(19) United States
(12) Patent Application Publication
(10) Pub. No.: US 2013/0174466 A1
(43) Pub. Date: Jul. 11, 2013

(54) DECOY STAND

(71) Applicant: Donald J. Saringer, Neenah, WI (US)

(72) Inventor: Donald J. Saringer, Neenah, WI (US)

(73) Assignee: MALLARD MOTELS, LLC, Appleton, WI (US)

(21) Appl. No.: 13/554,734

(22) Filed: Jul. 20, 2012

Related U.S. Application Data
(60) Provisional application No. 61/583,282, filed on Jan. 5, 2012.

(51) Int. Cl. A01M 31/06; F16M 11/20

(52) U.S. Cl. 43/2

(57) ABSTRACT

A decoy stand includes a tubular pole having a plurality of walls defining an outer periphery of the pole. The pole defines a longitudinal axis. The decoy stand also includes at least one slot elongated in a direction parallel to the longitudinal axis and positioned in each of the walls of the tubular pole, and at least one extension arm including a first arm portion that is received through one of the slots, and a second arm portion upon which a decoy is mountable.

### CROSS-REFERENCE TO RELATED APPLICATIONS

This application claims priority to co-pending U.S. Provisional Patent Application No. 61/583,282 filed on Jan. 5, 2012, the entire content of which is incorporated herein by reference.

### FIELD OF THE INVENTION

The present invention relates to decoy stands in general, and more particularly to an improved decoy stand assembly for deploying multiple decoys.

### BACKGROUND OF THE INVENTION

Decoys have been used extensively by hunters to attract duck, geese, and other fowl. Typically, decoys are mounted individually on a stand and may have wings that are movable (e.g., by wind gusts, by an electric motor, etc.) to give an appearance as if the decoy is flapping its wings.

### SUMMARY OF THE INVENTION

The invention provides, in one aspect, a decoy stand including a tubular pole having a plurality of walls defining an outer periphery of the pole. The pole defines a longitudinal axis. The decoy stand also includes at least one slot elongated in a direction parallel to the longitudinal axis and positioned in each of the walls of the tubular pole, and at least one extension arm including a first arm portion that is received through one of the slots, and a second arm portion upon which a decoy is mountable.

Other features and aspects of the invention will become apparent by consideration of the following detailed description and accompanying drawings.

### BRIEF DESCRIPTION OF THE DRAWINGS

FIG. 1 is a perspective view of a decoy stand of the invention.

FIG. 2 is an enlarged view of a portion of the decoy stand of FIG. 1.

FIG. 3 is an exploded view of a portion of the decoy stand of FIG. 1

FIG. 4 is cross-sectional view of a portion of the decoy stand of FIG. 1, taken along line 4-4 in FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

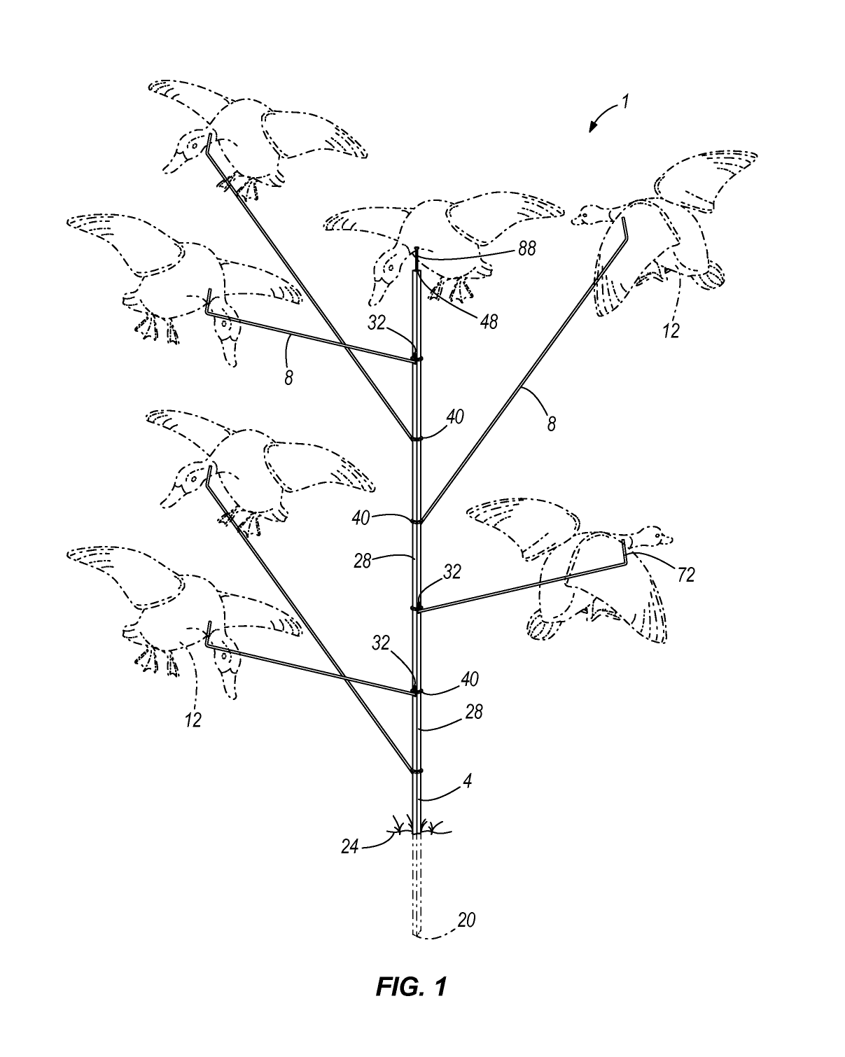

FIG. 1 illustrates a decoy stand 1 that includes a tubular pole 4, multiple extension arms 8 extending from the tubular pole 4, and decoys 12 supported on the extension arms 8, respectively. The pole 4 defines a longitudinal axis 16 (FIG. 3) and has a tapered lower end 20 to facilitate pushing the pole 4 into a support surface 24 (e.g., the ground). The pole 4 includes multiple walls 28 defining an outer periphery of the pole 4 and several slots 32, each elongated in a direction parallel to the longitudinal axis 16, through the walls 28 to allow access to an interior 34 of the pole 4 (FIGS. 1, 2, and 4). In the illustrated construction of the decoy stand 1, each of the walls 28 of the tubular pole 4 includes at least one slot 32. Particularly, the tubular pole 4 has a square cross-sectional shape and therefore four walls 28. Opposite walls 28 are substantially parallel to each other, while adjacent walls 28 are substantially normal to each other.

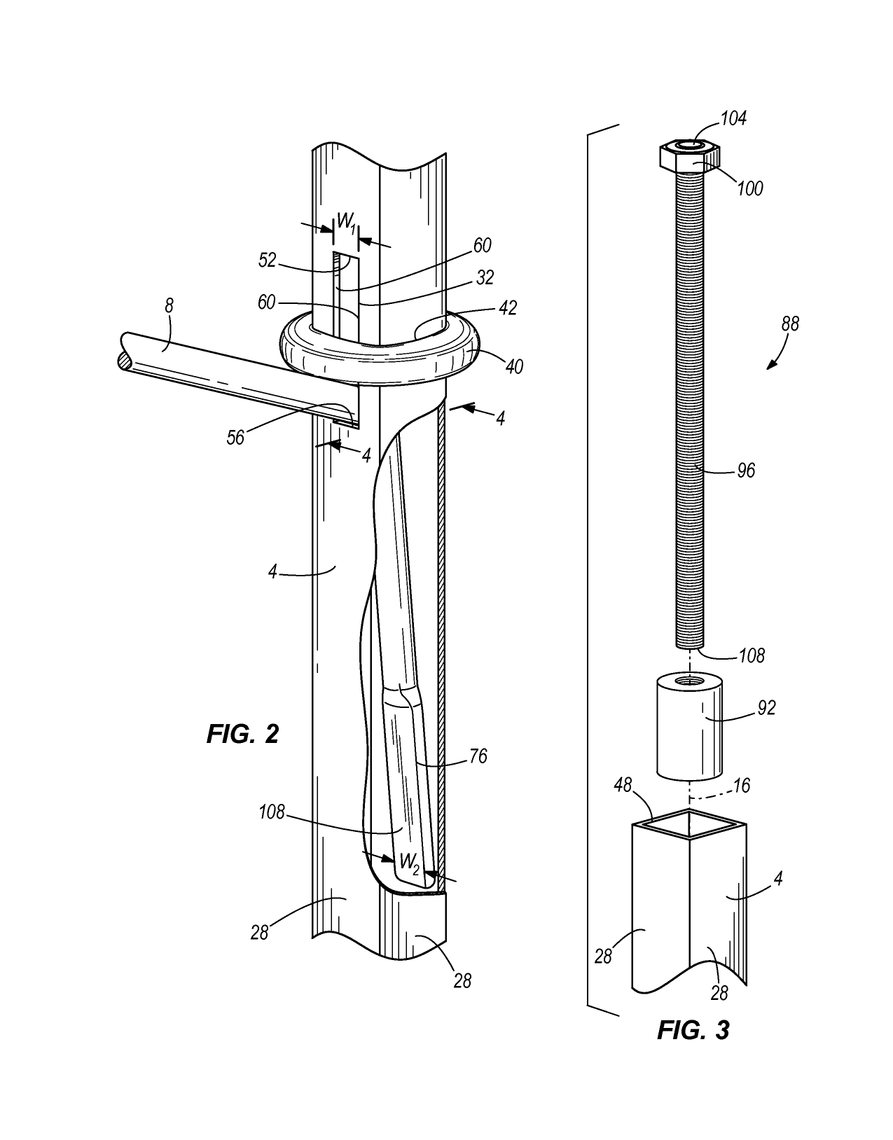

With reference to FIG. 1, the tubular pole 4 includes six slots 32 spaced from each other along the longitudinal axis 16. The six slots 32 are arranged on the pole 4 in a helical-like pattern, with vertically adjacent slots 32 being separated from each other by about 1 foot and located on adjacent walls 28 of the pole 4. In the illustrated construction of the decoy stand 1, a lower-most, first slot 32 on the tubular pole 4 is located about 2 feet above the lower tapered end 20 of the tubular pole 4. The next vertically adjacent slot 32 is located about 1 foot above the lower-most, first slot 32 and positioned on an adjacent wall 28 to the right of the wall 28 (from the frame of reference of FIG. 1) in which the lower-most slot 32 is located. Each of the remaining four slots 32 continue this pattern of about a 1 foot rise on the pole 4 and 90 degrees of rotation about the pole 4 in a counter-clockwise direction (i.e., looking down at the decoy stand 1 along the longitudinal axis 16) such that an upper-most, sixth slot 32 is located about 1 foot below an upper end 48 of the tubular pole 4. As such, two of the walls 28 each include two slots 32, and the remaining two walls 28 have one slot 32 each. By arranging the slots 32 in this pattern, the decoys 12 appear in a vertically staggered array around the pole 4. Alternatively, the pole 4 may include any number of slots 32 for arranging the decoys 12 in any of a number of different patterns or arrays around the pole 4. Each of the slots 32 is defined by a width W₁, an upper edge surface 52, a lower edge surface 56, and spaced, parallel side edge surfaces 60 (FIG. 2). Each of the surfaces 52, 56, 60 has a thickness coinciding with a thickness of the wall 28 in which the respective slot 32 is positioned.

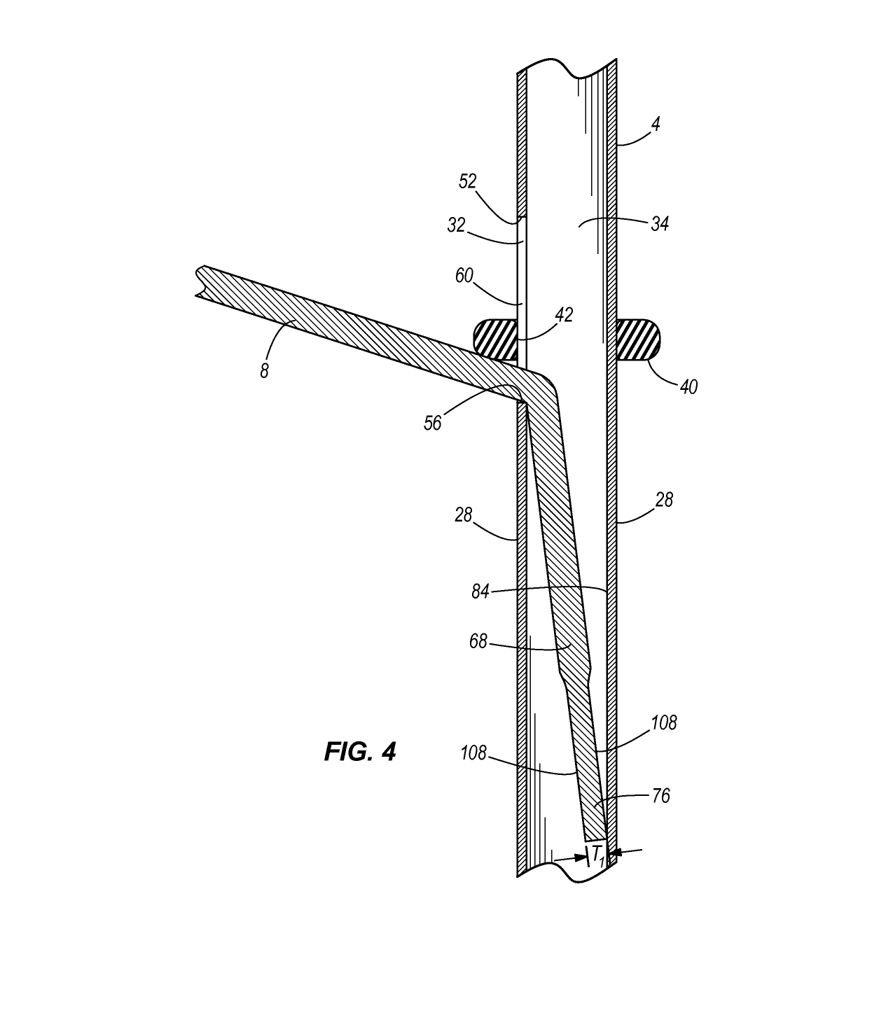

With continued reference to FIG. 1, each of the extension arms 8 is configured as a metal rod having a circular cross-sectional shape. Each of the extension arms 8 includes a first arm portion 68 received within one of the slots 32 (FIG. 4). The first arm portion 68 has a flattened distal end 76 that provides two opposed flat or planar surfaces 108. The flattened distal end 76 includes a width W₂ greater than the width W₁ of the slots 32 and a thickness T₁ less than the width W₁ of the slots 32 (FIGS. 2 and 4). From the frame of reference of FIG. 4, the width W₂ of the end 76 extends into the page and parallel with the upper and lower edge surfaces 52, 56 of the slot 32. As such, to insert the first arm portion 68 of each of the extension arms 8 into a respective slot 32 in the pole 4, the arm 8 must first be rotated 90 degrees to orient the flat or planar surfaces 108 of the distal end 76 approximately parallel to the side edge surfaces 60 of the slot 32. Once the first arm portion 68 is received through the slot 32, the extension arm 8 is then rotated in an opposite direction to allow one of the flat surfaces 108 of the distal end 76 to engage an interior surface 84 of a wall 28 of the pole 4. The interior surface 84 is oriented parallel to the particular wall 28 in which the slot 32 is located. In the orientation of the extension arm 8 and the flattened distal end 76 shown in FIG. 4, the arm 8 cannot be removed from the slot 32 because the width W₂ of the distal end 76 is greater than the width W₁ of the slot 32. Furthermore, to remove the arm 8 from the slot 32, the arm 8 must again be rotated 90 degrees to orient the planar surfaces 108 of the distal end 76 approximately parallel to the side edge surfaces 60 of the slot 32.

In other words, the configuration of the slots 32 and the flattened distal ends 76 of the extension arms 8 effectively functions as a locking mechanism for retaining the extension arms 8 to the pole 4 and preventing the extension arms 8 from being inadvertently removed from their respective slots 32 due the extension arm 8 and its respective decoy 12 swaying in the wind.

Each of the extension arms 8 is supported on the lower edge surface 56 of a respective slot 32 (FIGS. 2 and 4). As such, the lower edge surface 56 effectively functions as a fulcrum for the extension arm 8 for supporting the weight of the extension arm 8 and the decoy 12 mounted upon the extension arm 8. To limit the extent to which the extension arm 8 may pivot about the lower edge surface 56 of the slot 32, the flattened, distal end 76 of the first arm portion 68 is engageable with the interior surface 84 of a wall 28 of the pole 4 oriented parallel to the particular wall 28 in which the slot 32 is located and through which the first arm portion 68 protrudes (FIG. 4). It should be understood that the orientation of the extension arms 8 with the decoys 12 mounted thereon is determined by a combination of the length of the respective first arm portions 68 and the internal dimensions of the tubular pole 4. For example, the longer the first arm portions 68 and the smaller the internal dimensions of the tubular pole 4, the less the extension arms 8 may pivot about the lower edge surface 56 before the flattened, distal end 76 contacts the interior surface 84 of an opposite wall 28 to establish the assembled orientation of each of the extension arms 8.

The extension arm 8 is also engageable with the side edge surfaces 60 of the slot 32 to limit pivoting movement of the extension arm 8 relative to the tubular pole 4 caused by the decoys 12 swaying in the wind. Each of the extension arms 8 also includes a second arm portion 72 (FIG. 1), located opposite the first arm portion 68, upon which a respective decoy 12 is mountable. Particularly, the second arm portion 72 is upturned to assume a substantially vertical orientation with respect to the support surface 24. The second arm portion 72 is received within an aperture in the decoy 12 and when mounted, the decoy 12 assumes a substantially horizontal orientation with respect to the support surface 24. Although the extension arms 8 are shown oriented in an inclined manner relative to the tubular pole 4 in FIG. 1, the thickness or the diameter of the extension arms 8 may be sized to permit the extension arms 8 to bow or flex under the weight of the decoy 12 mounted thereon to an extent where the extension arms 8 may assume a generally horizontal orientation with respect to the support surface 24.

With continued reference to FIG. 1, the decoy stand 1 further includes elastic bands 40 positioned around the outer periphery of the tubular pole 4. Each band 40 is positioned over a slot 32 and is moveable or slideable on the pole 4 (FIG. 2). The bands 40 have a circular shape with an aperture 42 through which the pole 4 is received. The aperture 42 is sized with a pre-stretched diameter such that the bands 40 must be stretched when positioning the bands 40 around the pole 4. As such, the stretched bands 40 exert a radially inward (i.e., normal) force against the pole 4, thereby yielding a frictional force between each of the bands 40 and the pole 4. The bands 40 are made of rubber; however, the bands 40 may be made of any elastic material. When the bands 40 are positioned over the slots 32 to engage the respective extension arms 8, the frictional force between the bands 40 and the pole 4 is sufficiently high to prevent the arms 8 from lifting off the lower edge surfaces 56 of the respective slots 32, and potentially inadvertently falling out of the respective slots 32, during a period of high wind. In other words, the band 40 inhibits inadvertent removal of the extension arm 8 from the slot 32 as wind gusts cause the extension arm 8 to sway relative to the tube 4. To remove the extension arm 8 from the pole 4, a corresponding band 40 must first be moved away from the arm 8 by sliding the band 40 upwardly along the pole 4.

The decoy stand 1 further includes a mount 88 coaxially positioned at the upper end 48 of the tubular pole 4 (FIG. 1). The mount 88 includes a threaded insert 92, a threaded rod 96 received in the insert 92, and a nut 100 engaged with the threaded rod 96 (FIG. 3). In the illustrated construction of the decoy stand 1, the threaded insert 92 is secured within the upper end 48 of the tubular pole 4 using an interference or press-fit. Alternatively, the threaded insert 92 may be secured to the tubular pole 4 in any of a number of different manners (e.g., by welding, using fasteners or adhesives, etc.). When assembling the decoy stand 1, a lower end 108 of the threaded rod 96 is received through the threaded insert 92, with an upper end 104 of the threaded rod 96 remaining above the upper end 48 of the tubular pole 4. The exposed length of the rod 96 is adjustable by turning the rod 96 relative to the threaded insert 92 to raise or lower the decoy 12 supported by the mount 88. The position of the nut 100 is also adjustable relative to the upper end 104 of the threaded rod 96 to further adjust the mounted height of the decoy 12 on the mount 88.

With reference to FIG. 1, the decoy stand 1 is user configurable to adjust the number of decoys 12 that may be supported by the stand 1. The decoy stand 1 may be configured to use only one decoy 12 and as many as seven decoys 12. Up to six decoys 12 are detachably mounted on the extension arms 8, respectively, to locate the decoys 12 in a substantially horizontal orientation with respect to the support surface 24. Only one decoy 12 is detachably mounted on the mount 88, but the height of the decoy 12 on the mount 88 is adjustable as described above. By allowing a user to determine the number of decoys 12 used and their relative position, the decoy stand 1 provides the advantage of multiple decoy configurations within a single stand.

Various features of the invention are set forth in the following claims.

What is claimed is:

1. A decoy stand comprising:
a tubular pole including a plurality of walls defining an outer periphery of the pole, the pole defining a longitudinal axis;
at least one slot elongated in a direction parallel to the longitudinal axis and positioned in each of the walls of the tubular pole; and
at least one extension arm including a first arm portion that is received through one of the slots, and a second arm portion upon which a decoy is mountable.

2. The decoy stand of claim 1, wherein the tubular pole includes a square cross-sectional shape.

3. The decoy stand of claim 1, wherein the plurality of walls includes four walls.

4. The decoy stand of claim 1, wherein each of the slots is defined at least partially by a lower edge surface having a thickness coinciding with the thickness of the wall in which the respective slot is positioned, and wherein the extension arm is supported on the lower edge surface of the slot.

5. The decoy stand of claim 4, wherein the extension arm is configured as a metal rod having a circular cross-sectional shape.

6. The decoy stand of claim 5, wherein the slot in which the first arm portion is received is positioned within a first of the walls of the tubular pole, and wherein a distal end of the first arm portion is engaged with a second of the walls of the tubular pole.

7. The decoy stand of claim 6, wherein the first and second walls of the tubular pole are substantially parallel to each other.

8. The decoy stand of claim 6, wherein the distal end of the first arm portion includes opposed planar surfaces, and wherein one of the planar surfaces is engaged with the second wall of the tubular pole.

9. The decoy stand of claim 4, wherein each of the slots is defined at least partially by spaced, parallel side edge surfaces each having a thickness coinciding with the thickness of the wall in which the respective slot is positioned, and wherein the extension arm is engageable with one of the side edge surfaces to limit pivoting movement of the extension arm relative to the tubular pole.

10. The decoy stand of claim 9, wherein the first arm portion includes a flattened distal end having a width, wherein the slot through which the first arm portion is received includes a width defined between the spaced, parallel side edge surfaces, and wherein the width of the flattened distal end is greater than the width of the slot.

11. The decoy stand of claim 10, wherein the flattened distal end has a thickness less than the width of the slot.

12. The decoy stand of claim 1, wherein the at least one slot includes first and second slots spaced from each other along the longitudinal axis.

13. The decoy stand of claim 12, wherein the first and second slots are positioned on adjacent first and second walls, respectively, of the tubular pole.

14. The decoy stand of claim 13, wherein the first and second walls are substantially normal to each other.

15. The decoy stand of claim 1, further comprising a mount upon which a decoy is attachable, wherein the mount is coaxially coupled to the tubular pole.

16. The decoy stand of claim 1, wherein the tubular pole includes a tapered lower end to facilitate pushing the pole into a support surface.

17. The decoy stand of claim 1, wherein at least two of the walls each include two slots spaced from each other along the longitudinal axis.

18. The decoy stand of claim 1, further comprising a band positioned around the outer periphery of the tubular pole over the slot and engaged with the extension arm.

19. The decoy stand of claim 18, wherein the band is elastic and is capable of exerting a frictional force against the tubular pole.

20. The decoy stand of claim 18, wherein the band is slidable along the tubular pole away from the extension arm to disengage the extension arm.
